(19) United States
(12) Patent Application Publication
(10) Pub. No.: US 2006/0056377 A1
(43) Pub. Date: Mar. 16, 2006

(54) POWER-SAVING METHOD FOR A WLAN STATION

(76) Inventors: Chiung-hsien Wu, Taipei Hsien (TW); Ju-Nan Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,409

(22) Filed: Sep. 16, 2004

(51) Int. Cl. H04Q 7/00

(52) U.S. Cl. 370/345; 370/332

(57) ABSTRACT

A power-saving method for a station used in a WLAN where an access point sends out a plurality of beacons with a fixed period. When the station receives each fragment from the access point at different time points, it is determined if the station is set to a power saving mode by comparing the time difference of the received fragment and the beacon immediately prior to the fragment with a predetermined time.

### BACKGROUND OF INVENTION

1. Field of the Invention

The present invention relates to a power-saving method, and more particularly, to a power-saving method applied in a wireless communication system.

2. Description of the Prior Art

A network connects together stations in various locations so that digital data is quickly transmitted between the stations. In this manner, multiple users can share information with each other over the network. With special regard to the development of wireless networks over the recent years, because a physical network transmission line is not required, the ability to connect a station to a wireless network has brought the characteristics of portability and mobility to a user so that the user may access network resources at any place and at any time.

Because a Wireless Local Area Network (WLAN) is increasingly popular, the IEEE 802.11 WLAN standard is made for compatibility systems. The purpose of the IEEE 802.11 standard is to make a protocol for the WLAN operating environment, which focuses on constructing the MAC (Medium Access Control) layer and the physical layer.

Please refer to FIG. 1, which illustrates a block diagram of a prior art wireless network system 10. The network system 10 complies with IEEE 802.11 specifications, which are included herein by reference. The network system 10 comprises a server S1, a plurality of access points (two representative access points AP1 and AP2 are shown in FIG. 1), and a plurality of stations (four representative stations STA1, STA2, STA3, and STA4 are indicated in FIG. 1). The stations STA1 to STA4 and access points AP1 and AP2 all provide functionality for connecting to the wireless network 10. In other words, each of the stations and access points can send and receive wireless signals to transmit data. All transmitted data complies with a unified network protocol. Each of the access points AP1 and AP2 is separately connected to the server S1 so that data can be exchanged between the access point and server S1. Generally, when a station transmits wireless signals (such as radio waves or infrared radiation) to an access point, the effective transmission range is limited. An area R1, marked by a dotted line in FIG. 1, is representative of the area within which the access point AP1 and the stations STA1 and STA2 can effectively exchange wireless signals. Outside the area R1, the wireless signals transmitted from the access point AP1, station STA1, and station STA2 cannot be adequately received. Similarly, an area R2 is representative of the area within which the access point AP2, station STA3, and station STA4 can effectively exchange wireless signals. In order to expand the effective range of the stations in the wireless network 10, the server S1 is used to relay signal transmissions among the access points. One station can exchange data with another station by using the access point and server to relay the signals. Under this allocation scheme, not only can the wireless functionality of the stations be retained, but also the accessing range of the wireless network system 10 is further extended.

Transmission between the station STA1 and the access point AP1 is a power-consuming behavior. When the station STA1 is transmitting a packet, the station STA1 is in an active mode, and when the station STA1 is not sending any packet, the station STA1 is in a power saving mode. According to the 802.11 standard, a packet can be divided into several fragments to improve the performance. When the first fragment is sent, the receiving station STA1 keeps operating in the active mode until the last fragment is received. During this period, the station STA1 consumes power.

Please refer to FIG. 2. FIG. 2 illustrates the situation in which the fragments are sent according to the prior art. The packet 16 is divided into n fragments. The first fragment is sent at t1 and the last fragment is sent at t2 when the transmission of all the fragments is completed. There is a period of buffering time between every two transmitted fragments. During this period, no fragment is being sent, but power is still consumed. The period of buffering time is mainly caused by the time when the previous fragment is waiting for the next fragment and the network access delay. The network access delay is due to contention-based protocol of 802.11 standard.

In the prior art, during the buffering time between each transmitted fragment, the receiving station is in the active mode, consuming power. Moreover, the longer the buffering time, the more power a station consumes.

### SUMMARY OF INVENTION

It is therefore a primary objective of the claimed invention to provide a power-saving method to solve the above-mentioned problem.

According to the claimed invention, a power-saving method is used for a station in a WLAN. The station sends a plurality of periodical fragments to an access point and the access point sends a plurality of fragments to the station during an interval that is between a first beacon and a second beacon adjacent to the first beacon. The station receives the plurality of fragments at different time points after receiving the first beacon. The power-saving method includes a receiving station setting a MORE DATA BIT as enabled or disabled according to a duration between the first beacon and a received fragment. If a period between the first beacon and a fragment of the plurality of fragments received by the station after the first beacon is smaller than a predetermined time, the MORE DATA BIT is set as enabled and the station is in an active mode. If a period between the first beacon and a fragment of the plurality of fragments received by the station after the first beacon is not smaller than a predetermined time, the MORE DATA BIT is set as disabled and the station is in a power saving mode.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a block diagram of a prior art wireless network system.

FIG. 2 illustrates a situation in which the fragments are sent according to the prior art.

FIG. 3 illustrates the queuing method that an access point utilizes to send a plurality of fragments to a station in a wireless communication system.

FIG. 4 illustrates a flowchart of the power-saving method for wireless communication system according to the present invention.

FIG. 5 illustrates a station switching to the power saving mode.

FIG. 6 illustrates a wireless communication system according to the present invention.

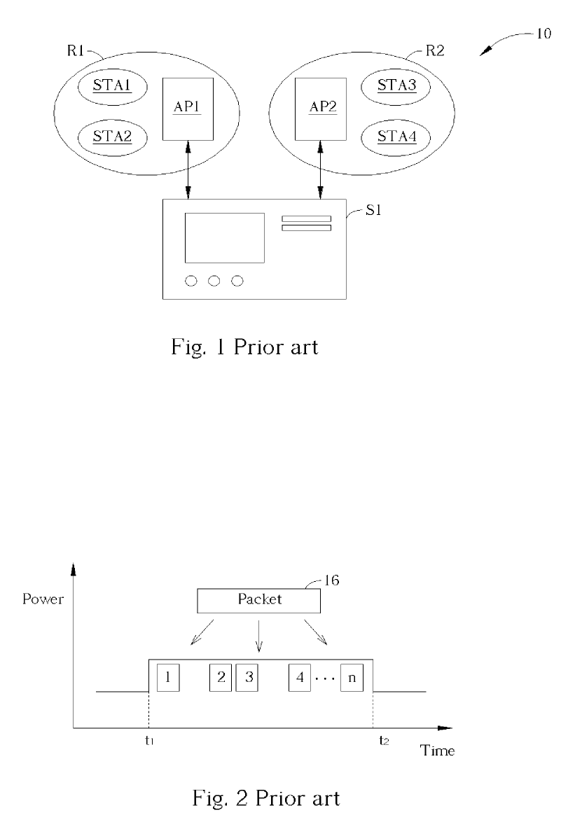

### DETAILED DESCRIPTION

Please refer to FIG. 3, which illustrates a queuing method that an access point utilizes to send a plurality of fragments to a station in a wireless communication system. A packet 21 is sent to a receiving station through the WLAN 26. As mentioned before, a packet is divided into several fragments according to the 802.11 standard. Therefore, the packet 21 is divided into n fragments, illustrated in FIG. 3 as the fragments marked with numbers 1 to n. The n fragments wait to be sent to a single-packet MAC buffer according to the sequence of the queue 22. The fragment No. 1 is sent to the single packet MAC buffer 24 first, and then is sent to the WLAN 26 from the single packet MAC buffer 24 to reach the station. During the transmission, the system undergoes two delays. One is queuing delay and the other is MAC delay. The delays involve the time interval taken for each sent fragment to arrive at a destination station.

The wireless communication system of the present invention belongs to the 802.11 standard. When one station of the wireless communication system sends a packet, the station is in the active mode. Otherwise, the station enters a power saving mode if no packets are being sent. Operating in the power saving mode means operating in a low power mode for the purpose of decreasing power consumption. When an access point communicates with a station of the wireless communication system, the access point will keep sending periodic beacons to the station. Because these beacons have a constant period, there is a constant time interval between each two beacons. In order to receive the periodic beacons, the station in the power saving mode must switch to the active mode before it is going to receive the beacon. The timing that the station switches from the power saving mode to the active mode is controlled by the synchronization between the station and the access point.

When an access point delivers a packet to a station, a signal of MORE DATA BIT will also be delivered. If MORE DATA BIT is set as Enable, it means plenty of packets are waiting to be transmitted. Therefore, the station is informed to be in the active mode. On the other hand, if MORE DATA BIT is set as Disable, the station is going to enter a power saving mode.

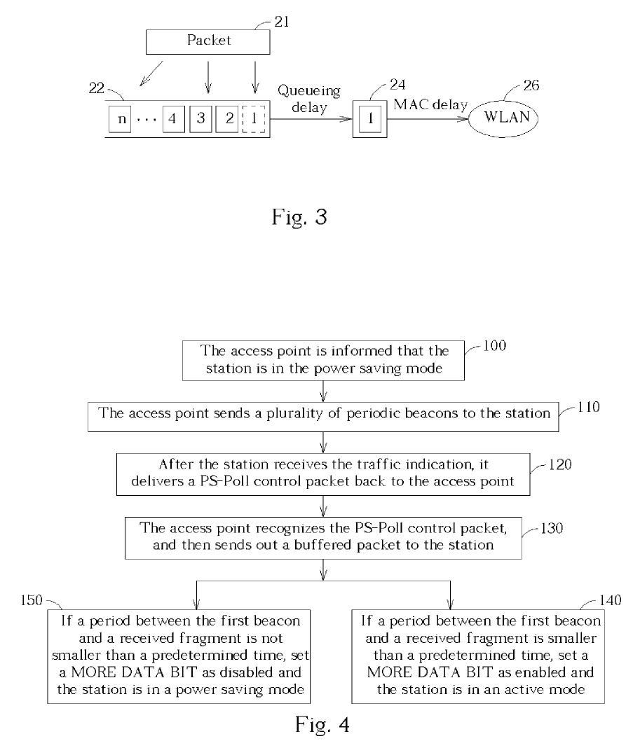

Please refer to FIG. 4, which illustrates a flowchart of the power-saving method for a wireless communication system according to the present invention. The flowchart describes how an access point sends a packet to a station in a power saving mode. In the step 100, the access point is informed that the station is in the power saving mode. In the step 110, the access point sends a plurality of periodic beacons to the station. If a plurality of fragments are going to be sent to the station, a nearest beacon (expressed as the first beacon here) sends a traffic indication to the station. In the step 120, after the station receives the traffic indication, it delivers a PS-Poll control packet back to the access point. In the step 130, the access point recognizes the PS-Poll control packet, and then sends out a buffered packet to the station. In the step 140, the station will receive a plurality of fragments at different time points. If a period between the first beacon and a received fragment is smaller than a predetermined time, the MORE DATA BIT is set as enabled and the station is in an active mode. Similarly, in the step 150, if a period between the first beacon and a received fragment is not smaller than a predetermined time, the MORE DATA BIT is set as disabled and the station is in a power saving mode. The sequence of the method in FIG. 4 can be changed according to different applications.

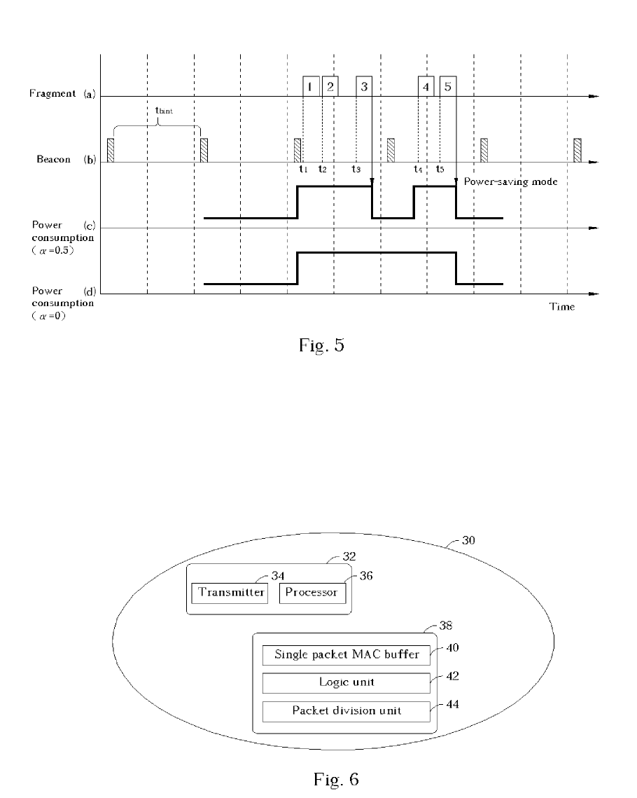

To describe step 140 and step 150 of FIG. 4 in greater detail, please refer to FIG. 5 that illustrates a preferred embodiment showing how a present invention station switches to the power saving mode. There are four sub-charts, (a), (b), (c), and (d) in FIG. 5. The horizontal axis of four sub-charts represents time. The chart (a) represents 5 fragments reaching the station at different time points. For example, the fragment 1 arrives at t1, the fragment 2 arrives at t2, the fragment 3 arrives at t3, the fragment 4 arrives at t4, and the fragment 5 arrives at t5. The chart (b) represents the station receiving a plurality of periodic beacons at different time points and the interval between each two adjacent beacons is t_{bint}. The vertical axis of chart (c) and chart (d) represent power consumption. Charts (c) and (d) represent power consumption of a station under different values of a parameter α (the meaning of the parameter α will be described later).

In the present invention, the way to determine when a station enters power saving mode is according to the following equation: tᵢ−t_{beacon}<t_{bint}*(1−α), where 1≧α≧0, tᵢ is the time at which each fragment arrives at the station, t_{beacon} is the time when the station receives a plurality of beacons, and t_{bint} is the interval between each two adjacent beacons. The parameter α is used for determining the predetermined time in steps 140 and 150 in FIG. 4. Thus, tᵢ−t_{beacon} is a period between the time point when the station receives a fragment and the time point when the station receives the previous beacon. If the equation is satisfied, the MORE DATA BIT is set to be enabled and the station is in the active mode. If the equation is not satisfied, the MORE DATA BIT is set to be disabled and the station is in the power saving mode.

Take FIG. 5 as an example, t_{bint}=200 ms, t1−t_{beacon}=15 ms, t2−t_{beacon}=70 ms, t3−t_{beacon}=140 ms, t4−t_{beacon}=70 ms, t5−t_{beacon}=120 ms. If α is 0.5, t_{bint}*(1−α)=100 ms. Therefore, the station starts to operate at t1, and enters the power saving mode at t3. After time point t4, the station enters the active mode and it enters the power saving mode again after t5. In a special case, if α is set to be zero, the equation is always satisfied. Therefore, the station is in the active mode between each two received packets.

Please refer to FIG. 6, which illustrates a wireless communication system 30 having a power-saving function according to the present invention. The wireless communication system 30 comprises an access point 38 and a station 32. The access point 38 comprises a transmitter 34 and a processor 26. The access point 38 further comprises a single packet MAC buffer 40, a logic unit 42, and a packet division unit 44. The wireless communication system 30 is the apparatus that can implement the method of FIG. 4. The access point 38 is used to send a plurality of periodic beacons and send a plurality of fragments between two successive periodic beacons. The packet division unit 44 is used for dividing a packet into a plurality of fragments and sending the plurality of fragments sequentially to the single packet MAC buffer 40. The fragments stored in the single packet MAC buffer 40 are waiting to be sent to the station 32 by the access point 38.

When the access point 38 is informed that the station 32 is in the power saving mode, it sends a traffic indication to the station 32 through a beacon. After the station 32 receives the traffic indication, the transmitter 34 sends back a PS-Poll control packet to the access point 38. The logic unit 42 in the access point 38 recognizes the PS-Poll control packet and then the access point 38 sends a buffer packet to the station 32. The station will receive a plurality of fragments at different time points. The processor 36 is used to set a MORE DATA BIT as enabled and the station 32 is in an active mode if a period between the received fragment and the beacon immediately prior to the received fragment is smaller than a predetermined time. The processor 36 sets a MORE DATA BIT as disabled and the station 32 is in a power saving mode if a period between the received fragment and the beacon immediately prior to the received fragment is not smaller than a predetermined time.

In the prior art, during the buffering time between each transmitted fragment, the receiving station is in the active mode, in which the station consumes power. However, power can be saved in the buffering time. Moreover, the longer the buffering time is, the more power a station consumes, leading to extra power waste. In a power-saving method for a station used in a WLAN where the station receives a plurality of fragments from an access point, the access point sends out a plurality of beacons with a fixed period. When the station receives each fragment from the access point at different time points, it is determined if the station is set to a power saving mode by comparing the time difference of the received fragment and the beacon immediately prior to the fragment with a predetermined time. If a period between the received fragment and the beacon immediately before the received fragment is smaller than a predetermined time, the station enters the active mode. If a period between the received fragment and the beacon immediately before the received fragment is not smaller than a predetermined time, the station enters the power saving mode. Because the station will not waste power in the power-saving method, the method and the wireless communication system of the present invention have the advantage of low power consumption.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power-saving method for a station used in a WLAN, an access point sending a plurality of fragments to the station during an interval which is between a first beacon and a second beacon adjacent to the first beacon, the station receiving the plurality of fragments at different time points after receiving the first beacon, the power-saving method comprising:
if a period between the first beacon and a fragment of the plurality of fragments received by the station after the first beacon is smaller than a predetermined time, setting a MORE DATA BIT as enabled and the station is in an active mode; and
if a period between the first beacon and a fragment of the plurality of fragments received by the station after the first beacon is not smaller than a predetermined time, setting the MORE DATA BIT as disabled and the station is in a power saving mode.

2. The power-saving method of the claim 1 further comprising informing the access point that the station is in the power saving mode.

3. The power-saving method of the claim 1 further comprising the access point delivering a traffic indication to the station through the first beacon.

4. The power-saving method of the claim 1 further comprising the station delivering a PS-Poll control packet to the access point.

5. The power-saving method of the claim 4 further comprising the access point recognizing the PS-Poll control packet and sending a buffer packet to the station.

6. The power-saving method of the claim 1 further comprising dividing a packet into the plurality of fragments.

7. The power-saving method of the claim 6 further comprising sending the plurality of fragments to a single-packet MAC buffer.

8. The power-saving method of the claim 7 further comprising sending the plurality of fragments to a WLAN from the single-packet MAC buffer.

9. The power-saving method of the claim 1 wherein the plurality of fragments comprises sound information.

10. The power-saving method of the claim 1 wherein the wireless communication system is wireless IP phone.

11. The power-saving method of the claim 1 wherein a ratio of the predetermined time to the interval between the first beacon and the second beacon is between 0 and 1 inclusive.

12. A wireless communication system with a power-saving function, the wireless communication system comprising:
an access point for sending a plurality of periodic beacons and sending a plurality of fragments during an interval between a first beacon and a second beacon adjacent to the first beacon, the first beacon comprising a traffic indication; and
a station for receiving the first beacon and receiving the plurality of fragments at different time points after the first beacon is received, the station comprising:
a processor for setting a MORE DATA BIT as enabled and the station is in an active mode if a period between the first beacon and a fragment of the plurality of fragments received by the station after the first beacon is smaller than a predetermined time, and setting a MORE DATA BIT as disabled and the station is in a power saving mode if a period between the first beacon and a fragment of the plurality of fragments received by the station after the first beacon is not smaller than the predetermined time.

13. The wireless communication system of the claim 12 wherein the station further comprises a transmitter for sending a PS-Poll control packet to the access point.

14. The wireless communication system of the claim 13 wherein the access point further comprises a logic unit for recognizing the PS-Poll control packet.

15. The wireless communication system of the claim 13 wherein the access point is further used for sending a buffer packet.

16. The wireless communication system of the claim 12 wherein the access point further comprises a packet division unit for dividing a packet into a plurality of fragments.

17. The wireless communication system of the claim 16 wherein the access point further comprises a single-packet MAC buffer for storing the plurality of fragments.
